(19) United States
(12) Patent Application Publication
(10) Pub. No.: US 2026/0359737 A1
(43) Pub. Date: Nov. 12, 2026

(54) TRAVEL RESERVATION ASSISTANCE SYSTEM WITH CONTEXTUALIZATION

(71) Applicant: Expedia, Inc., Seattle, WA (US)

(72) Inventors: Barbara Johnson, Seattle, WA (US); Jason Luke, Seattle, WA (US); Alayna Rouse, Seattle, WA (US); Bogdan Popp, Seattle, WA (US)

(73) Assignee: Expedia, Inc., Seattle, WA (US)

(21) Appl. No.: 19/673,904

(22) Filed: May 11, 2026

Related U.S. Application Data
(60) Provisional application No. 63/804,497, filed on May 12, 2025.

(51) Int. Cl. G06Q 10/02; G06F 40/20

(52) U.S. Cl. CPC G06Q 10/021; G06F 40/20

(57) ABSTRACT

At least one aspect relates to a travel reservation management system. The system may receive, via a graphical user interface (GUI), a request for assistance in modifying the travel reservation. The system may determine a plurality of potential actions for modifying the travel reservation. The system may generate a prompt indicating the plurality of potential actions and reservation information associated with the travel reservation, to cause an artificial intelligence agent to generate a contextual summary of the plurality of potential actions indicating a recommended action of the plurality of potential actions. The system may generate an interface portion corresponding to the travel reservation including the contextual summary and selectable elements corresponding to the plurality of potential actions. The system may receive an interaction with a selectable element of the selectable elements corresponding to a first potential action. The system may implement the first potential action to adjust the travel reservation.

### CROSS REFERENCE TO RELATED PATENT APPLICATION

This application claims the benefit of and priority to U.S. Provisional Patent Application No. 63/804,497, filed May 12, 2025, which is incorporated herein by reference in its entirety.

### TECHNICAL FIELD

The present disclosure relates generally to managing reservations. More specifically, the present disclosure relates to managing travel reservations.

### BACKGROUND

When modifying travel reservations, customers typically seek the assistance of travel agents. This may cause difficulties modifying reservations during certain times, such as non-business hours, weekends, and/or holidays. Further, limitations associated with reservation searching features may cause difficulties in finding relevant information relating to modifying travel reservations through self-help systems.

### SUMMARY

At least one aspect relates to a travel reservation management system. The system may include a non-transitory computer-readable medium having instructions stored thereon that, when executed by one or more processors, cause the one or more processors to receive, via a graphical user interface (GUI) generated on a user device associated with a user account, a request associated with a travel reservation, the request including a natural language request for assistance in modifying the travel reservation. The instructions may further cause the one or more processors to determine, based on contextual information associated with the request and account information associated with the user account, that the travel reservation is associated with the user account. The instructions may further cause the one or more processors to determine, based on the contextual information associated with the request, a plurality of potential actions for modifying the travel reservation. The instructions may further cause the one or more processors to generate a prompt for transmission to an artificial intelligence agent indicating the plurality of potential actions and reservation information associated with the travel reservation. The instructions may further cause the one or more processors to transmit the prompt to the artificial intelligence agent to cause the artificial intelligence agent to generate a contextual summary of the plurality of potential actions, the contextual summary indicating a recommended action of the plurality of potential actions. The instructions may further cause the one or more processors to generate, for display on the GUI, an interface portion corresponding to the travel reservation, the interface portion including the contextual summary and selectable elements corresponding to the plurality of potential actions. The instructions may further cause the one or more processors to receive, via the GUI, an interaction with a selectable element of the selectable elements corresponding to a first potential action of the plurality of potential actions. The instructions may further cause the one or more processors to implement the first potential action to adjust one or more features of the travel reservation.

Another aspect relates to a method for modifying travel reservations. The method may include receiving, a request associated with a travel reservation, the request including a natural language request for assistance in modifying the travel reservation. The method may include determining, based on contextual information associated with the request and account information associated with a user account, that the travel reservation is associated with the user account. The method may include determining, based on the contextual information associated with the request, a plurality of potential actions for modifying the travel reservation. The method may include generating a prompt for transmission to an artificial intelligence agent indicating the plurality of potential actions and reservation information associated with the travel reservation. The method may include transmitting the prompt to the artificial intelligence agent to cause the artificial intelligence agent to generate a contextual summary of the plurality of potential actions, the contextual summary indicating a recommended action of the plurality of potential actions. The method may include receiving an indication of a first potential action of the plurality of potential actions. The method may include implementing the first potential action to adjust one or more features of the travel reservation.

Another aspect relates to a travel reservation management system. The system may include a non-transitory computer-readable medium having instructions stored thereon that, when executed by one or more processors, cause the one or more processors to receive, from a graphical user interface (GUI) generated on a user device associated with a user account, a request associated with a travel reservation, the request including a natural language request for assistance in modifying the travel reservation, retrieve, based on contextual information associated with the request, a plurality of documents corresponding to the contextual information, retrieving the plurality of documents including identifying the plurality of documents from among a database of documents based at least in part on an estimated relevance of the documents to the request, generate a prompt using the request and the retrieved one or more documents and provide the prompt to a generative artificial intelligence model to generate a summary response to the request, and generate, for display on the GUI, a first interface portion including at least a portion of the summary response.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a system for intelligent searching and modification of travel reservations, according to some examples.

FIG. 2 is a flow diagram of a method for modifying travel reservations using the system of FIG. 1, according to some examples.

FIG. 3 is a flow diagram of a method for modifying travel reservations using the system of FIG. 1, according to some examples.

FIG. 4 is a graphical user interface generated using the system of FIG. 1, according to some examples.

FIG. 5 is a graphical user interface generated using the system of FIG. 1, according to some examples.

FIG. 6 is a graphical user interface generated using the system of FIG. 1, according to some examples.

FIG. 7 is a graphical user interface generated using the system of FIG. 1, according to some examples.

FIG. 8A is a graphical user interface generated using the system of FIG. 1, according to some examples.

FIG. 8B is a graphical user interface generated using the system of FIG. 1, according to some examples.

FIG. 9A is a graphical user interface generated using the system of FIG. 1, according to some examples.

FIG. 9B is a graphical user interface generated using the system of FIG. 1, according to some examples.

FIG. 9C is a graphical user interface generated using the system of FIG. 1, according to some examples.

FIG. 10 is a graphical user interface generated using the system of FIG. 1, according to some examples.

The details of various embodiments of the methods and systems are set forth in the accompanying drawings and the description below.

### DETAILED DESCRIPTION

Following below are more detailed descriptions of various concepts related to, and implementations of, methods, apparatuses, and systems of managing travel reservations. Before turning to the figures, which illustrate certain examples in detail, it should be understood that the present disclosure is not limited to the details or methodology set forth in the description or illustrated in the figures. The various concepts introduced above and discussed in greater detail below can be implemented in any of numerous ways. It should also be understood that the terminology used herein is for the purpose of description only and should not be regarded as limiting.

Referring generally to the figures, some systems and methods described herein relate to context-driven AI based summaries to assist users in handling requests. The system may receive a request associated with a user device relating to a travel reservation. The request may be a natural language request for assistance in modifying the travel reservation. The system may identify contextual information of the request, such as indications of a travel reservation, a type of travel reservation, a date associated with a travel reservation, and/or an intent associated with the request, among other information. Based on the identified contextual information, the system may undergo a retrieval augmented generation (RAG) process to prompt an AI model to generate a summary response to the request. The system may identify one or more documents corresponding to the contextual information. For example, the system may perform semantic comparison between the contextual information and passages of the document to identify relevant information (e.g., documents, passages, etc.). Based on the identified documents, the system may generate a prompt for input to the AI model causing the AI model to generate a summary response. The summary response may be displayed on a graphical user interface (GUI) of the user device to assist the user in modifying a travel reservation.

Additionally, or alternatively, some systems and methods described herein relate to travel reservation modification assistance. The system may determine, based on the contextual information of the request, whether there are travel reservations for the user associated with the request. For example, the system may filter the travel reservations based on the contextual information. Based on the request and the identified reservations, the system may determine one or more potential actions corresponding to the reservations. The potential actions may be actions for modifying reservations, obtaining refunds, managing accounts, among other actions. These potential actions may be displayed on the user device as selectable elements, and the user may interact with the selectable elements to initiate one or more potential actions.

In some implementations, systems and methods described herein relate to using virtual agents to assist in modifying travel reservations. These virtual agents may be artificial intelligence agents trained and/or prompted to execute certain tasks associated with modifying travel reservations. For example, the virtual agents may receive prompts indicating a plurality of potential actions that can be taken to resolve a request. The virtual agents may use domain-specific information, such as reservation information, policy information, or other information to predict outcomes associated with each of the plurality of potential actions. The virtual agents may then generate contextual summaries associated with the potential actions. The contextual summaries may include descriptions of the potential actions, predicted outcomes associated with the potential actions, and/or a recommendation indicating a recommended potential action.

In some implementations, the virtual agents may be implemented within a chatbot environment. The chatbot environment may be accessible via the GUI generated on the user device and may present a conversational interface through which a user can submit text-based and/or speech-based requests associated with a travel reservation. The system may route user inputs received via the chatbot environment to one or more of the virtual agents based on contextual information associated with the request, such as an identified intent or reservation type. The selected virtual agent may generate conversational responses, follow-up questions, recommendations, and/or selectable elements corresponding to potential actions for display within the chatbot environment. In some implementations, the chatbot environment may maintain state information across multiple exchanges such that the virtual agent can use prior user inputs, identified reservation information, and previously presented action options to provide contextually relevant assistance during an ongoing conversation.

In some instances, users may consult with travel agents (e.g., humans) to modify travel reservations. This may present certain challenges when modifying reservations during certain times, such as weekends, holidays, and nights, among other times where travel agents may not be available to assist. As users wait for travel agents to become available, the system may waste computing resources and increase computational overhead by maintaining communication links between users and the agents that are not actively being used. In some cases, the increase in computational overhead may result in increased system latency. There may also be certain challenges associated with automating processes to modify travel reservations through computer-implemented techniques. For example, it may be difficult for a system to identify a specific travel reservation that is being indicated in a request. As another example, it may be difficult for a system to provide recommendations that are specific to the requests themselves rather than templated or genericized. These challenges may degrade the quality of recommendations or assistance provided by these systems, which may require multiple requests to be made to make a proper modification to a travel reservation. This may further waste computing resources and/or contribute to system latency as a length of user sessions and a number of transmissions increases.

By implementing the virtual agents within the chatbot environment, systems and methods described herein can reduce computational resource waste and system latency. For example, the system may use contextual information associated with a request to map the request to one or more travel reservations associated with a user account, thereby reducing the likelihood of an attempt to perform a modification on the wrong reservation. Additionally, or alternatively, the system may use the contextual information to select a particular virtual agent from among a plurality of virtual agents configured to perform different reservation-related tasks. For example, a first virtual agent may be selected for cancellation-related requests, a second virtual agent may be selected for refund-related requests, and a third virtual agent may be selected for confirmation or account-management requests. By mapping the request to a relevant reservation and routing the request to a task-specific virtual agent, the system may reduce unnecessary processing associated with generalized workflows, and/or reduce a number of follow-up interactions needed to identify an appropriate action.

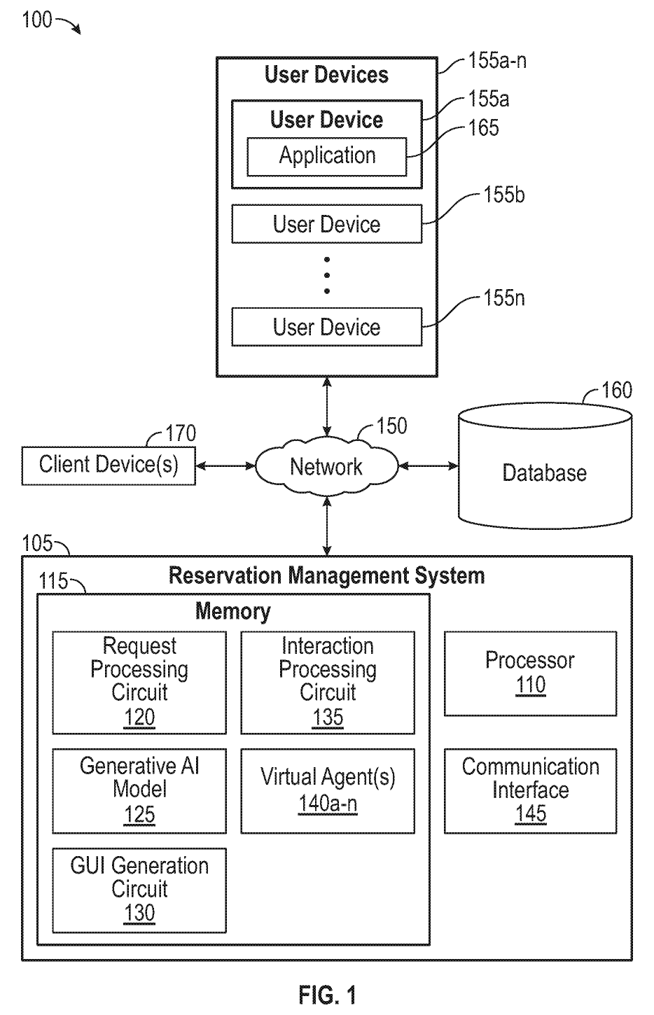

FIG. 1 depicts an example system 100 for searching and modification of travel reservations. For example, the system 100 can include at least one reservation management system 105, a network 150, user devices 155a-n (referred to collectively as “user devices 155”), a database 160, and client devices 170a-n (referred to collectively as “client devices 170”).

The reservation management system 105 can include at least one processor 110. The processor 110 may be a single processor 110, or multiple processors 110 (e.g., multiple processors working alone or together to perform one or more steps or tasks together, such as in a distributed or cloud computing environment). The processor 110 can be implemented as a general-purpose processor, an application specific integrated circuit (ASIC), one or more field programmable gate arrays (FPGAs), an artificial intelligence (AI) processor (such as a neural processing unit (NPU) and tensor processing unit (TPU), a super scalar processor, a group of processing components, or other suitable electronic processing components.

The reservation management system 105 is shown to include memory 115. Memory 115 is shown as including several components, including a request processing circuit 120, a generative artificial intelligence (AI) model 125 (also referred to as “AI model 125”), a graphical user interface (GUI) generation circuit 130, an interaction processing circuit 135, and a plurality of virtual agents 140a-n (referred to collectively as “virtual agents 140”). In some examples, these components may be implemented as instructions stored within memory 115 or one or more other computer-readable storage media that are executable by the processor(s) 110 to perform various functions described herein. In some implementations, the components may additionally or alternatively be implemented in part or in whole using hardware. All such alternatives are contemplated within the scope of the present disclosure.

The memory 115 (e.g., memory, memory unit, storage device, etc.) may include one or more devices (e.g., RAM, ROM, flash memory, hard disk storage, etc.) for storing data and/or computer code for completing or facilitating the various processes, layers, and modules described in the present application. The memory 115 can be or include volatile memory or non-volatile memory. The memory 115 can include database components, object code components, script components, or any other type of information structure for supporting the various activities and information structures described in the present application. According to an example, the memory 115 is communicably coupled to the processor 110 and includes computer code for executing (e.g., by the processor 110) one or more processes described herein.

The memory 115 may include the request processing circuit 120. In various implementations, the request processing circuit 120 can include any combination of hardware or software for processing instructions, such as instructions for providing functionalities of the reservation management system 105. The request processing circuit 120 may store instructions for extracting (e.g., determining) contextual information of a request provided to the reservation management system 105. For example, the reservation management system 105 may receive a natural language request (e.g., from a user device 155, via the network 150) associated with a travel reservation for assistance in modifying the travel reservation. In some implementations, the request processing circuit 120 may identify contextual information associated with the request to determine search criteria.

As referred to herein, contextual information associated with the request may indicate a travel reservation, a type of travel reservation, a date associated with a travel reservation, and/or an intent associated with the request, among other information. For example, the contextual information may specify a specific reservation associated with a user account associated with the user device 155, via an indicator such as a confirmation number or a name (e.g., of an airline, of a hotel, etc.) associated with the reservation. As another example, the contextual information may specify a type of travel reservation, such as a hotel, a flight, an experience, a rental car, or a different type of reservation. As yet another example, the contextual information may indicate a date or other time-based indicator of a reservation. As yet another example, the contextual information may indicate an intent associated with a reservation, such as a cancellation, modification, viewing a confirmation, or changing a date of a reservation, among other information. In some implementations, the request processing circuit 120 may apply natural language processing (NLP) techniques or other processes to the request to extract the contextual information. For example, the request processing circuit 120 may use keyword matching, semantic similarity, or other language processing techniques to extract the contextual information.

In some implementations, the request processing circuit 120 may use the contextual information as search criteria for document searching. For example, the request processing circuit 120 may categorize the contextual information into criteria such as reservation types, dates, intents, or other search criteria to perform a search. According to an example implementation, the request processing circuit 120 may initiate a retrieval augmented generation (RAG) process. The request processing circuit 120 may use the search criteria to identify and retrieve one or more documents (e.g., articles, presentations, books, blog posts, websites, etc.) corresponding to the contextual information associated with the request. The one or more documents may be stored in the database 160 or may be retrieved from a different source (e.g., via the network 150). The request processing circuit 120 may use the one or more documents and/or the request to generate a prompt for the AI model 125. The prompt may cause the AI model 125 to generate a summary response (e.g., document summary response) for the request. For example, the prompt may cause the AI model 125 to extract relevant information from the one or more documents and generate a summary of the information. The AI model 125 may extract relevant information based on an estimate of the relevance of the documents or particular portions of the documents.

In some examples, the memory 115 may store, keep, hold, or otherwise maintain the database 160. Additionally, or alternatively, the reservation management system 105 may be communicatively coupled with the database 160 directly and/or over the network 150. The database 160 may include at least one of a computing device, a remote server, a server bank, a remote device, and/or other possible computer hardware and/or computer software. As described above, the database 160 may store (e.g., keep, hold, maintain) a plurality of documents associated with travel reservations. For example, the documents may include articles, manuals, policies, or other documents including information associated with travel reservations. In some implementations, each document may include a vector embedding representing the document to be used for the RAG process. For example, the request processing circuit 120 may generate a request vector embedding corresponding to the request, and may search the database 160for documents relevant to the request by calculating a similarity between the request vector embedding and vector embeddings representing the documents.

Additionally, or alternatively, the database 160 may store a plurality of information segments. Rather than being entire documents, the information segments may include shorter, more targeted information related to a specific topic. For example, each information segment may represent a specific fact or a specific policy associated with travel reservations. By storing information as information segments rather than or in addition to whole documents, the request processing circuit 120 may be able to perform more targeted searches of the database 160 for information related to requests. For example, the request processing circuit 120 may retrieve individual information segments that are relevant to a request rather than an entire document which may include some information that is not relevant to the request. This may also conserve computing resources associated with processing information from the database 160, as the information segments may allow the request processing circuit 120 to avoid processing whole documents to extract relevant information.

The request processing circuit 120 may determine whether there are one or more travel reservations associated with the request. For example, the request processing circuit 120 may determine, based on the contextual information associated with the request, a reservation type associated with the request. The reservation type may correspond to a type of reservation (e.g., hotel, activity, flight, etc), a time of reservation (e.g., date, past future, etc.), or other information associated with reservations. The request processing circuit 120 may retrieve account information for a user account that made the request. For example, the user account may have one or more travel reservations (e.g., future reservations, past reservations). The request processing circuit 120 may compare the determined reservation type to reservations of the user account to determine whether there are travel reservations associated with the request.

Based on whether there are travel reservations of the user account associated with the request and the contextual information of the request, the request processing circuit 120 may determine one or more potential actions (e.g., modifications, notifications, etc.) for the reservations. For example, for a request that identifies that the user would like to modify a travel reservation, the request processing circuit 120 may determine potential actions to modify the travel reservations. As another example, for a request that identifies that the user would like to send a reconfirmation message (e.g., email, text, etc.), the request processing circuit 120 may determine potential actions to modify the travel reservations. The number of potential actions determined by the request processing circuit 120 may vary depending on the request and the number of identified reservations.

The memory 115 is shown to include the AI model 125. Additionally, or alternatively, the reservation management system 105 may communicate with the AI model 125 via application programming interface (API) requests. In some implementations, the AI model 125 is a language model, such as a large language model. The request processing circuit 120 may transmit a prompt to the AI model 125. The prompt may include the one or more documents or information segments retrieved from the database 160 and/or contextual information associated with the request. In instances where the prompt includes documents, the prompt may cause the AI model 125 to analyze (e.g., process, scan, search) the one or more documents for relevant information for responding to the request. In some implementations, the AI model 125 may rank or otherwise determine a priority associated with the information extracted from the one or more documents. For example, the AI model 125 may determine which information in the documents is most relevant for responding to the request. Based on the extracted information, the AI model 125 may generate a natural language summary of the one or more documents to respond to the request. While the illustrated implementation shows the generative AI model 125 being included within the memory 115, it should be understood that, in some embodiments, the AI model 125 may be stored on a separate computing system that may or may not be controlled or owned by a part that controls or owns the reservation management system 105 (e.g., a model provided by a third party that can be invoked to providing prompts via an API or other interface and returns a response/output).

The memory 115 is shown to include the GUI generation circuit 130. In various implementations, the GUI generation circuit 130 can include any combination of hardware or software for processing instructions, such as instructions for providing functionalities of the reservation management system 105. The GUI generation circuit 130 may store instructions for generating (e.g., creating, arranging, etc.) GUIs corresponding to managing travel reservations. The GUIs may allow a user to input a request (e.g., natural language request) corresponding to a travel reservation. For example, the GUI generation circuit 130 may generate an interface portion that allows the user to input text for further processing by the request processing circuit 120. In some implementations, the GUIs may allow a user to input a speech-based request. For example, the GUI generation circuit 130 may generate an interface portion that activates a microphone or other recording device of the user device 155 to record audio including spoken utterances.

In some embodiments, the GUI generation circuit 130 may generate one or more interface portions corresponding to summary responses to requests generated by the AI model 125. For example, the GUI generation circuit 130 may generate a text box to be displayed on a GUI that contains the summary response. In some embodiments, the GUI generation circuit 130 may generate one or more interface portions corresponding to potential actions determined by the request processing circuit 120. For example, the GUI generation circuit 130 may generate one or more selectable elements (e.g., buttons, icons, sliders, text boxes, etc.) corresponding to each potential action. For example, responsive to an interaction with a selectable element, the reservation management system 105 may undergo a potential action corresponding to the selectable element.

The memory 115 may include the interaction processing circuit 135. In various implementations, the interaction processing circuit 135 can include any combination of hardware or software for processing instructions, such as instructions for providing functionalities of the reservation management system 105. The interaction processing circuit 135 may receive interaction data associated with selectable elements generated by the GUI generation circuit 130. For example, responsive to a user interaction with a selectable element, the interaction processing circuit 135 may undergo (e.g., initiate) a potential action associated with the selectable element. The interaction processing circuit 135 may initiate a plurality of different actions associated with travel reservations. For example, the interaction processing circuit 135 may modify reservations, cancel reservations, resend confirmations, cause generation of additional interface portions to be displayed (e.g., by the GUI generation circuit 130), initiate a conversation with the virtual agents 140, among other actions.

The memory 115 is shown to include the virtual agents 140. In some implementations, the virtual agents 140 may include artificial intelligence agents trained to perform specific tasks with respect to modifying travel reservations. For example, the virtual agents 140 may include an advisory artificial intelligence agent trained to provide recommendations associated with modifying travel reservations. As another example, the virtual agents 140 may include another artificial intelligence agent trained to answer user queries associated with travel reservations. In some implementations, the virtual agents 140 may include or be accessible via a chatbot to receive and respond to user inputs (e.g., queries). For example, the virtual agents 140 may act as a chatbot to provide recommendations to users associated with modifying travel reservations and/or assisting users with queries. As an example, a user device 155 may enter (e.g., via the chatbot) a question to the virtual agents 140 asking the virtual agents 140 for phone numbers, website details, troubleshooting inquiries, among other requests, related and/or unrelated to managing travel reservations. Additionally, or alternatively, the virtual agent 140 may allow the user to input follow-up requests responsive to the request processing circuit 120 misidentifying potential actions. In some implementations, the interaction with the user may begin with a help interface managed by the request processing circuit 120 and the request processing circuit 120 may invoke or call the virtual agent 140 to complete an interaction and the user and/or perform certain tasks in relation to modifying the reservation.

In some implementations, the request processing circuit 120 may use contextual information associated with a request to select one or more of the virtual agents 140 to assist with modifying a travel reservation. For example, the request processing circuit 120 may identify an intent associated with a request, and select one of the virtual agents 140 associated with the intent. According to an example implementation, a user device 155 may transmit a request to the reservation management system 105 associated with cancelling a reservation. The request processing circuit 120 may determine contextual information associated with the request to determine that the intent of the request is to cancel a reservation. Based on determining the intent, the request processing circuit 120 may determine potential actions that can be taken with respect to cancelling the reservation, and may select a virtual agent 140 that can generate a recommendation for the user. The recommendation may indicate a recommended action of the potential actions associated with the request.

The reservation management system 105 may transmit messages to the client devices 170 (e.g., via the network 150). The client devices 170 may be devices, such as a mobile computing device, a desktop computer, a smartphone, a tablet, a smart watch, and/or any other device belonging to an entity associated with the travel reservation. For example, a first client device 170a may belong to a hotel associated with a first travel reservation. As another example, a second client device 170n may belong to airline associated with a second travel reservation. In some implementations, the reservation management system 105 may transmit messages generated by the virtual agents 140. For example, a virtual agent 140 may generate a message for transmission to a client device 170 requesting cancellation of a travel reservation. As another example, a virtual agent 140 may generate a message for transmission to a client device 170 requesting modification of a travel reservation. In response to transmitting messages to the client devices 170, the reservation management system 105 may receive responses from the client devices 170 and route the responses (e.g., to the virtual agents 140) for further processing.

The reservation management system 105 may be communicatively coupled to the user devices 155, the client devices 170 and/or the database 160 via a communication interface 145. The communication interface 145 can include at least one of network communication devices, network interfaces, and/or other possible communication interfaces. The communication interface 145 can include wired or wireless communications interfaces (e.g., jacks, antennas, transmitters, receivers, transceivers, wire terminals, etc.) for conducting data communications with various systems, devices, and/or components described herein. The communication interface 145 can be direct (e.g., local wired or wireless communications) and/or via a communications network (e.g., the network 150). For example, the communication interface 145 can include an Ethernet card and port for sending and receiving data via an Ethernet-based communications link or network. The communication interface 145 can include a Wi-Fi transceiver for communicating via a wireless communications network (e.g., the network 150). The communication interface 145 can include a power line communications interface. The communication interface 145 can include an Ethernet interface, a USB interface, a serial communications interface, and/or a parallel communications interface.

In some examples, the network 150 may include at least one of a local area network (LAN), a wide area network (WAN), a telephone network (such as the Public Switched Telephone Network (PSTN)), a Controller Area Network (CAN), a wireless link, an intranet, the Internet, a cellular network, and/or combinations thereof. In some examples, the various systems, components, and/or other devices included in the system 100 may communicate with one another via the network 150. For example, the network 150 may receive interaction data (e.g., with an application 165 or webpage) from one of the user devices 155 and facilitate the transfer of the data to the reservation management system 105 for processing. The network 150 may include a microservice that is designated for transmitting the behavior data. The network 150 may be configured to transmit (e.g., deploy) messages (e.g., communications), interface portions, and other information to the user devices 155. In some examples, the network 150 may include a pipeline to distribute information to the various user devices 155. In some examples, the network 150 be communicatively coupled to the database 160. The database 160 may be a cloud-based database, such as a data lake. The database may be used for large-scale storage to store large volumes of travel reservation data for user devices 155 that has been accumulated over a period of time.

The user devices 155 may perform various actions and/or access various types of information. The information may be provided over the network 150. For example, the user devices 155 may be a mobile computing device, a desktop computer, a smartphone, a tablet, a smart watch, and/or any other device that can facilitate receiving and otherwise interacting with content from the network 150. The user devices 155 may display GUIs generated by the GUI generation circuit 130. For example, the GUIs may include interface portions corresponding to inputting requests, summary responses, selectable elements for potential actions, among other interface portions. The user device may include an application 165 or be able to access a webpage with the application 165. The application 165 and/or webpage may store instructions such that when the user devices 155 interact with the webpage, interaction (e.g., activity, behavior, etc.) data can be transmitted to the reservation management system 105 (e.g., via the network 150). The application 165 and/or the webpage may associate travel reservation data with an identifier of the user devices 155 associated with a user account. For example, the application 165 and/or webpage may allow a user device 155 to create an account that generates an identifier of the user device. As another example, the application 165 and/or webpage may track an IP address of the user devices 155, thereby allowing the reservation management system 105 to identify and/or retrieve travel reservation data for a specific user device 155. While the AI model 125 and other components are shown as being implemented within the reservation management system 105, it should be understood that, in various embodiments, the various features, functions, and components shown as implemented in the reservation management system 105 could be implemented in the user devices 155 (e.g., as a part of the application 165) or implemented in part on the user devices 155 and in part on the reservation management system 105.

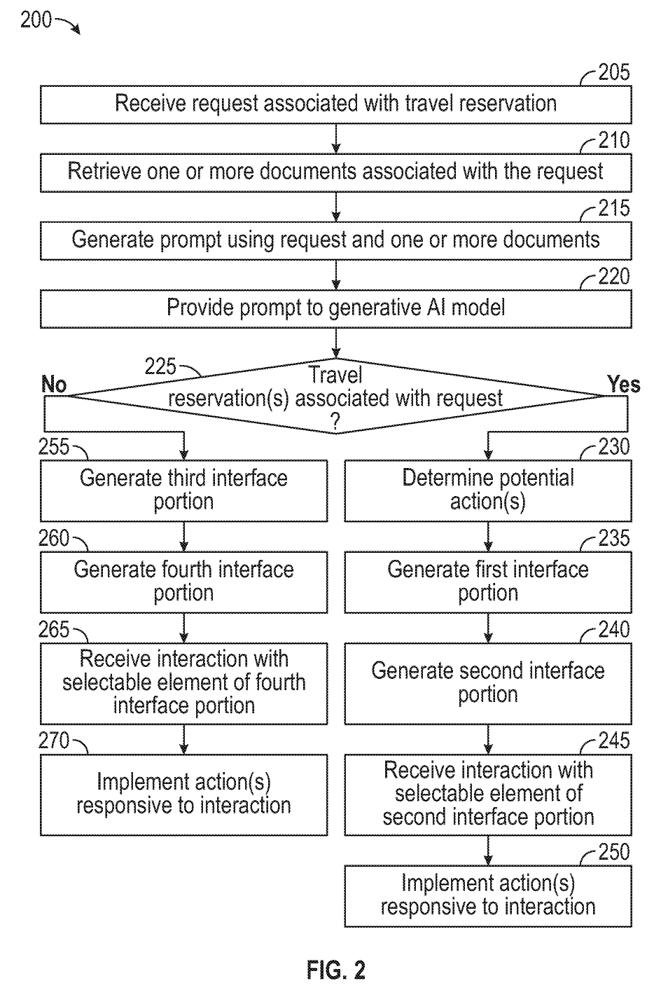

FIG. 2 depicts a flow diagram of an example method 200 for modifying travel reservations. The method 200 may represent and/or illustrate one or more steps, actions, processes, and/or transmissions to receive, process, store, display and/or otherwise personalize travel reservation management for user accounts. The method 200 and/or one or more portions thereof may be executed by and/or carried out by the system 100 and/or one or more systems, devices, components, and/or elements thereof, in some implementations. The method 200 is meant to be an example and is not intended to be limiting. In various embodiments, steps of the method 200 may be omitted, added, and/or ordered differently than the embodiment described herein. Further, in some implementations, systems and/or components different from those shown in FIG. 1 may be used to implement/execute the features and steps shown in and described with respect to FIG. 2.

Referring now to FIGS. 1 and 2, at step 205 of method 200, the request processing circuit 120 may receive a request associated with a travel reservation. The request may be a natural language request, such as a text-based request or a speech-based request. The request processing circuit 120 may extract or otherwise determine contextual information associated with the request. For example, the request processing circuit 120 may determine a reservation type (e.g., hotel, flight, activity, etc.) of the request, a time associated with the request (e.g., past, future, specific date, etc.), an action type (e.g., cancel, modify, reschedule, etc.), a destination, among other features of travel reservations. The request may be inputted by a user device 155 to the application 165 or a webpage, and be transmitted to the reservation management system 105 via the network 150.

At step 210 of method 200, the request processing circuit 120 may retrieve one or more documents associated with the request (e.g., contextual information of the request). The documents may include publications, books, presentations, articles, webpages, blog posts, among other document types. The documents may include relevant information for answering (e.g., responding to) the request. The request processing circuit 120 may search (e.g., analyze, scan, parse) the documents for information relevant to the request. For example, the request processing circuit 120 may identify passages of the documents that are most relevant (e.g., important) for responding to the request. The request processing circuit 120 may use semantic comparison of the document passages to the context associated with the request to determine which documents are most relevant to the request.

At step 215, the request processing circuit 120 may generate a prompt using the request and the one or more documents. The prompt may include entire documents, or may include identified (e.g., selected) passages of the one or more documents. The prompt may include the request and/or the contextual information associated with the request. The prompt may cause the AI model 125 to generate a summary response of the documents to respond to the request. At step 220, the request processing circuit 120 may provide the prompt to the generative AI model 125. The AI model 125 may receive the prompt, and generate a summary response to the request based on the information included in the prompt. In some embodiments, the AI model 125 may operate under certain constraints, such as a limit on the length of the summary response, a number of documents included in the response, an allotted processing time, among other constraints. These constraints may limit the amount of computing resources the AI model 125 uses to generate the response, and reduce the amount of time associated with generating the summary response.

At step 225, the request processing circuit 120 may determine whether there are one or more travel reservations associated with the request. The request processing circuit 120 may retrieve travel reservation data associated with the user device 155 and/or a user account that entered the request. For example, the request processing circuit 120 may retrieve information associated with past reservations and future reservations. The travel reservation data may include various information of travel reservations, such as reservation time and date, reservation type (e.g., hotel, flight, activity, etc.), reservation amenities, reservation modification capabilities, among other information.

The request processing circuit 120 may use the travel reservation data and the contextual information of the request to determine whether there are travel reservations of the user account associated with the request. For example, the contextual information may identify information of a specific travel reservation. The request processing circuit 120 may compare the travel reservation data to the contextual information to identify one or more reservations relevant to the request. For example, if the request identifies a reservation type, the request processing circuit 120 may filter the reservations of the account based on the reservation type. As another example, if the request identifies a reservation time, the request processing circuit 120 may filter the reservation of the account based on the reservation time.

At step 230, responsive to a determination that there are one or more travel reservations associated with the request, the request processing circuit 120 may determine one or more potential actions for the request and the reservations. The one or more potential actions may be based on contextual information of the request. For example, the request may identify a desire to modify a reservation, resend a confirmation, chat with the virtual agents 140, among other actions. In some embodiments, the one or more potential actions may include actions relating to modifying reservations, such as rescheduling, cancelling, or otherwise adjusting travel reservations. In some embodiments, the one or more potential actions may include initiating a conversation with a chatbot accessible by the virtual agents 140. In some embodiments, the one or more potential actions may include sending confirmation messages (e.g., emails, text messages, notifications, etc.).

At step 235, the GUI generation circuit 130 may generate a first interface portion for display on the user device 155. The first interface portion may include the summary response generated by the AI model 125. Additionally, or alternatively, the first interface portion may allow the user to access (e.g., via embedded links, selectable elements, etc.) the one or more documents used to generate the summary response. At step 240, the GUI generation circuit 130 may generate a second interface portion for display on the user device 155. The second interface portion may include one or more selectable elements corresponding to the one or more potential actions. For example, a first selectable element may correspond to a first potential action, and a second selectable element may correspond to a second potential action.

The second interface portion may include one or more selectable elements corresponding to a plurality of different travel reservations. In some embodiments, if the request processing circuit 120 is unable to filter the travel reservations to a single reservation based on contextual information of the request, the second interface portion may allow the user to select a travel reservation before selecting a potential action. In some embodiments, the second interface portion may include a plurality of selectable elements corresponding to the same potential action, but for different travel reservations. For example, the second interface portion may have a first selectable element to cancel a first travel reservation, and a second selectable element to cancel a second travel reservation.

At step 245, the interaction processing circuit 135 may receive an interaction with a selectable element of the second interface portion. For example, responsive to a user interaction with a selectable element, the user device 155 may transmit a message to the interaction processing circuit 135 (e.g., via the network 150) indicating a potential action to initiate. At step 250, responsive to the interaction processing circuit 135 receiving an interaction with a selectable element of the second interface portion, the interaction processing circuit 135 may initiate one or more actions corresponding to the selectable element. For example, the interaction processing circuit 135 may cause the GUI generation circuit 130 to generate additional interface portions for display. As another example, the interaction processing circuit 135 may cause the virtual agent 140 to be displayed and initiate a conversation. As yet another example, the interaction processing circuit 135 may reroute the user to a different page to modify a travel reservation.

At step 255, responsive to the request processing circuit 120 determining that there are no travel reservations of the user account that are associated with the request, the GUI generation circuit 130 may generate a third interface portion. In some embodiments, the third interface portion may include a summary response generated by the AI model 125. In some embodiments, the third interface portion may indicate that no travel reservations were found corresponding to the request. In some embodiments, the third interface portion may ask the user to input a different request. In some embodiments, the third interface portion may include embedded links to allow the user to access a frequently-asked-questions (FAQ) page or include information for contacting a customer assistance provider.

At step 260, the GUI generation circuit 130 may generate a fourth interface portion. The fourth interface portion may include one or more predetermined selectable elements. The predetermined selectable elements may be default selectable elements for when no reservations are found for the user account. For example, the default selectable elements may allow the user to chat with the virtual agent 140, search for specific bookings, or view account information, among other actions.

At step 265, the interaction processing circuit 135 may receive an interaction with a selectable element of the fourth interface portion. For example, responsive to a user interaction with a selectable element, the user device 155 may transmit a message to the interaction processing circuit 135 (e.g., via the network 150) indicating a default action to initiate. At step 270, responsive to the interaction processing circuit 135 receiving an interaction with a selectable element of the fourth interface portion, the interaction processing circuit 135 may initiate one or more actions corresponding to the selectable element. For example, the interaction processing circuit 135 may cause the GUI generation circuit 130 to generate additional interface portions for display. As another example, the interaction processing circuit 135 may cause the virtual agent 140 to be displayed and initiate a conversation. As yet another example, the interaction processing circuit 135 may reroute the user to a different page to search for a travel reservation.

Still referring to FIGS. 1 and 2, in some embodiments, certain steps of the method 200 may be completed and others omitted, to facilitate certain functions of the system 100. According to an example embodiment, steps of the method 200 may be completed using the system 100 to manage travel reservations without generating a summary response (e.g., using the AI model 125). The request processing circuit 120 may receive a request associated with a travel reservation (e.g., as shown in step 205). The request processing circuit 120 may determine whether there are one or more travel reservations of a user account associated with the request (e.g., as shown in step 225). The request processing circuit 120 may determine one or more potential actions based on the contextual information associated with the request (e.g., as shown in step 230). The GUI generation circuit 130 may generate the second interface portion corresponding to the one or more travel reservations, including at least one selectable element corresponding to the one or more potential actions (e.g., as shown in step 240). The interaction processing circuit 135 may receive an interaction with a selectable element of the second interface portion (e.g., as shown in step 245). The interaction processing circuit 135 may implement one or more potential actions responsive to the interaction with the selectable element (e.g., as shown in step 250).

According to an example embodiment, steps of the method 200 may be completed using the system 100 to generate a summary response for a request without implementing actions associated with modifying travel reservations. The request processing circuit may receive a request associated with a travel reservation (e.g., as shown in step 205). The request processing circuit 120 may retrieve, based on contextual information associated with the request, a plurality of documents corresponding to the contextual information (e.g., as shown in step 210). The request processing circuit 120 may generate a prompt using the request and the one or more documents, and provide the prompt to the AI model 125 to generate a summary response to the request (e.g., as shown in step 215 and step 220). The GUI generation circuit 130 may generate a first interface portion including at least a portion of the summary response (e.g., as shown in step 235).

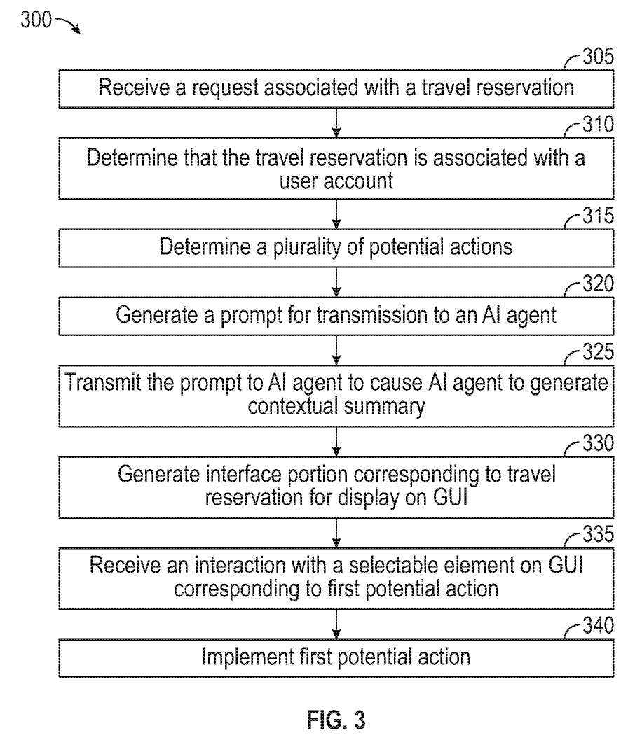

FIG. 3 depicts a flow diagram of an example method 300 for managing travel reservations. The method 300 may represent and/or illustrate one or more steps, actions, processes, and/or transmissions to receive, process, store, display and/or otherwise personalize travel reservation management for user accounts. The method 300 and/or one or more portions thereof may be executed by and/or carried out by the system 100 and/or one or more systems, devices, components, and/or elements thereof, in some implementations. The method 300 is meant to be an example and is not intended to be limiting. In various embodiments, steps of the method 300 may be omitted, added, and/or ordered differently than the implementation described herein. Further, in some implementations, systems and/or components different from those shown in FIG. 1 may be used to implement/execute the features and steps shown in and described with respect to FIG. 3.

Certain steps of the method 300 may involve generating GUIs, displaying GUIs, and/or receiving information via GUIs. It should be understood that all descriptions of GUIs associated with the method 300 describe example implementations, and are in no way limiting. Further, certain steps of the method 300 may be performed without GUIs. For example, rather than displaying a GUI or receiving information via a GUI, the method 300 may involve presenting generated spoken utterances to a user, or receiving information via spoken utterances.

Referring to FIGS. 1 and 3, at step 305, the reservation management system 105 may receive a request associated with a travel reservation from a user device 155. In some implementations, the user device 155 may transmit the request to the reservation management system 105 via a GUI generated by the reservation management system 105 on the user device 155. For example, the GUI may include a text box, a drop-down menu, a selectable element, or a different interactive element that allows a user of the user device 155 to enter a text-based request. As another example, the GUI may activate a microphone of the user device 155 to allow a user of the user device 155 to enter a speech-based request. In some implementations, the reservation management system 105 may associate the user device 155 and/or the request with a user account. For example, the reservation management system 105 may determine, based on metadata or other information associated with the request, that the user device 155 corresponds to a user account for making travel reservations.

At step 310, the reservation management system 105 may determine, based on contextual information associated with the request and account information associated with the user device 155, that the travel reservation indicated in the request is associated with the user account. As described above, the contextual information may include indicate a travel reservation, a type of travel reservation, a date associated with a travel reservation, and/or an intent associated with the request, among other information. The reservation management system 105 may compare the contextual information to one or more travel reservations associated with the user account to determine a travel reservation associated with the request.

In some instances, there may be multiple travel reservations associated with the user account that may be referenced in the request. For example, if the language included in the request is broad and/or vague, the reservation management system 105 may determine that there are multiple travel reservations associated with the user account corresponding to the travel reservation. In such cases, the reservation management system 105 may facilitate determining which travel reservation associated with the user account is the travel reservation indicated in the request. In some implementations, the reservation management system 105 may generate, for display on the GUI of the user device 155, a preliminary interface portion. The preliminary interface portion may include a selectable element corresponding to each travel reservation of the multiple travel reservations that may correspond to the request. The reservation management system 105 may receive an interaction with a first selectable element of the selectable elements corresponding to a first travel reservation of the multiple travel reservations. As such, the reservation management system 105 can determine that the travel reservation associated with the request is the first travel reservation.

At step 315, the reservation management system 105 may determine, based on contextual information associated with the request, a plurality of potential actions for modifying the travel reservation. According to an example implementation, the reservation management system 105 may identify an intent associated with the request based on the contextual information. For example, the reservation management system 105 may use the contextual information determine that the request is a request to cancel a reservation, modify a reservation, view a reservation confirmation, or ask a question related to a reservation, among other intents. Based on the type of request, the reservation management system 105 may determine potential actions associated with the request type. For example, if the request is to cancel a reservation, the plurality of potential actions may include cancelling the travel reservation (e.g., requesting a refund), modifying a time corresponding to the travel reservation, and/or contacting a client device 170 associated with the travel reservation, among other examples.

As described above, the reservation management system 105 may determine a request type of a plurality of request types based on the contextual information. For example, the request type may include cancelling a reservation, modifying a reservation, resending a confirmation, and/or asking a question related to a reservation, among other reservation types. The reservation management system 105 may determine the plurality of potential actions based on the request type. For example, each request type may have a plurality of predetermined potential actions that can be taken to resolve the request. In some implementations, each request type may be associated with an artificial intelligence agent (e.g., virtual agent 140) trained to resolve requests of a certain request type. For example, the artificial intelligence agent may store or have access to domain knowledge associated with the request type that allows the artificial intelligence agent to provide recommendations and/or implement selected actions. In response to determining the request type, the reservation management system 105 may select an artificial intelligence agent corresponding to the request type from among a plurality of artificial intelligence agents (e.g., virtual agents 140) corresponding to the plurality of request types.

At step 320, the reservation management system 105 may generate a prompt for transmission to an artificial intelligence agent (e.g., selected based on the request type). The prompt may indicate the plurality of potential actions and/or reservation information associated with the travel reservation. For example, the reservation information may include a reservation cost, a reservation date, at least a portion of the contextual information, and/or other information associated with the reservation.

At step 325, the reservation management system 105 may transmit the prompt to the artificial intelligence agent to cause the artificial intelligence agent to generate a contextual summary of the plurality of potential actions. In some implementations, the contextual summary indicates a recommended action of the plurality of potential actions. As described above, the artificial intelligence agent may be trained using and/or have access to domain knowledge associated with the request type that allows the artificial intelligence agent to analyze the plurality of potential options, predict outcomes, and/or generate recommendations to assist the user device 155 in selecting a potential action for resolving the request.

According to an example implementation, the artificial intelligence agent may retrieve, based on the reservation information, policy information associated with the travel reservation. In some implementations, the artificial intelligence agent may retrieve the policy information from the database 160. The policy information may include guidelines or other information related to modifying the travel reservation, such as cancellation policies, refund policies, modification policies, among other information. In some implementations, the policy information may be specific to an entity (e.g., hotel, airline, etc.) associated with the travel reservation. In some implementations, the policy information may be global policy information applicable to all reservations of the reservation type.

The artificial intelligence agent may use the policy information to determine predicted outcomes associated with the plurality of potential actions. According to an example implementation, if the request is associated with cancelling a travel reservation, the policy information may include cancellation policies, refund policies, modification policies, and/or other policies associated with canceling and/or modifying a reservation. For each potential action, the artificial intelligence agent may use the policy information to determine at least one of an estimated refund associated with the potential actions, a likelihood of success associated with the travel reservation, and/or a likelihood that the potential action satisfies the request. The artificial intelligence agent may combine one or more of these metrics into an assessment of each potential action. The artificial intelligence agent may compare the assessments for each potential action to generate the contextual summary indicating the recommended action. The contextual summary may further indicate other information associated with the potential actions, such as the predicted outcomes, likelihood of success, and/or other information associated with the potential actions.

At step 330, the reservation management system 105 may generate an interface portion corresponding to the travel reservation for display on the GUI. The interface portion may include the contextual summary (e.g., generated by the artificial intelligence agent) and selectable elements corresponding to the plurality of potential actions. In some implementations, the interface portion may include a summary response associated with the request. As referred to herein, the summary response may be the summary response described with reference to FIGS. 1 and 2. As an example, the reservation management system 105 may retrieve, based on the contextual information associated with the request, a plurality of documents corresponding to the contextual information from the database 160 based on an estimated relevance of the documents to the request. The reservation management system 105 may generate a prompt using the request and the plurality of documents to provide to an artificial intelligence model (e.g., the AI model 125) to generate the summary response. The reservation management system 105 may then generate the interface portion to include at least a portion of the summary response.

In some implementations, in response to displaying the interface portion, the reservation management system 105 may receive a query associated with a potential action of the plurality of potential actions. For example, the reservation management system 105 may receive the query in response to an interaction with a chatbot interface of the interface portion. The reservation management system 105 may facilitate generating and displaying a response to the query. The reservation management system 105 may retrieve, from the database 160, one or more information segments corresponding to the query and the at least one potential action. In some implementations, the reservation management system 105 may retrieve the one or more information segments based on a semantic similarity of the query to the information segments, a mapping between the potential action and the one or more information segments, keyword matching, and/or vector similarity, among other techniques.

In response to retrieving the one or more information segments, the reservation management system 105 may generate a prompt for transmission to the artificial intelligence agent. The prompt may indicate the query, the at least one potential action, and the one or more information segments. The reservation management system 105 may then transmit the prompt to the artificial intelligence agent, to cause the artificial intelligence agent to generate a response to the query. According to an example implementation, in response to a request from a user device 155 to cancel a travel reservation, the interface portion may indicate that a first potential action corresponds to requesting a partial refund. Based on the interface portion, the reservation management system 105 may receive a query asking, ‘Why is a full refund unavailable?’ To generate a response to the query, the reservation management system 105 may retrieve one or more information segments corresponding to a cancellation policy associated with the travel reservation, and may generate a prompt indicating the request, the potential action (e.g., the partial refund), and the one or more information segments. The artificial intelligence agent may generate a response to the query indicating why the full refund is not available, and may provide the response to the user device 155 via the GUI.

At step 335, the reservation management system 105 may receive an interaction with a selectable element of the selectable elements corresponding to a first potential action of the plurality of potential actions. The interaction may indicate that the user device 155 has selected the first potential action to be implemented by the reservation management system 105. In some implementations, the interaction is based on a user of the user device 155 selecting a button corresponding to the first potential action. In some implementations, the interaction is based on a user of the user device 155 entering a text-based input indicating the first potential action. In some implementations, the interaction is based on a speech-based utterance into the user device 155 indicating the first potential action.

At step 340, the reservation management system 105 may implement the first potential action to adjust one or more features of the travel reservation. For example, adjusting one or more features of the travel reservation may include cancelling the travel reservation, modifying the travel reservation, adjusting a time associated with the travel reservation, re-sending a confirmation of the travel reservation, and/or transmitting a message to a client device 170. In some implementations, the first potential action indicates a request to contact a client device 170 associated with the travel reservation to request cancellation of the travel reservation. For example, if an automated cancellation is not available for the reservation, the first potential action may allow the user to communicate with the client device 170 to request cancellation. The reservation management system 105 may use the artificial intelligence agent to generate a natural language message including a request for cancellation. In some implementations, the message may indicate a reason for cancellation. The reservation management system 105 may prompt the user device 155 to approve the message, and in response to receiving an approval of the message (e.g., via the GUI), the reservation management system 105 may transmit the message to the client device 170.

In some implementations, before generating the message, the reservation management system 105 may generate an additional interface portion for display on the GUI. The additional interface portion may request a reason for cancellation of the travel reservation. The additional interface portion may include a text box, a drop-down menu, a checklist, or a different interactive element that allows the user to input a reason for cancellation. In response to receiving the reason for cancellation (e.g., via an interaction with the additional interface portion), the reservation management system 105 may provide the reason for cancellation to the artificial intelligence agent. The artificial intelligence agent may generate the natural language message including the request for cancellation and the reason for cancellation. The reservation management system 105 may then transmit the message to the client device 170. It should be understood that the reservation management system 105 may transmit the message to the client device 170 via one or more of a plurality of delivery channels. For example, the reservation management system 105 may transmit the message as a text-based message, an email message, an automated voice message, an instant message, and/or a different type of message.

In some implementations, in response to sending the message, the reservation management system 105 may monitor for a response from the client device 170. The reservation management system 105 may receive a response from the client device 170 indicating whether the request for cancellation was granted. If the reservation management system 105 determines that the request for cancellation was granted, the reservation management system 105 may transmit a notification to the user device 155 indicating that the reservation was cancelled. If the reservation management system 105 determines that the request for cancellation was not granted, the reservation management system 105 may generate an additional prompt for transmission to the artificial intelligence agent. The additional prompt may indicate the response from the client device 170 and one or more remaining potential actions. The one or more remaining potential actions may be a subset of the original potential actions excluding contacting the client device 170. The additional prompt may cause the artificial intelligence agent to generate an updated contextual summary of the plurality of potential actions. For example, the updated contextual summary may indicate an updated recommended action of the one or more remaining potential actions.

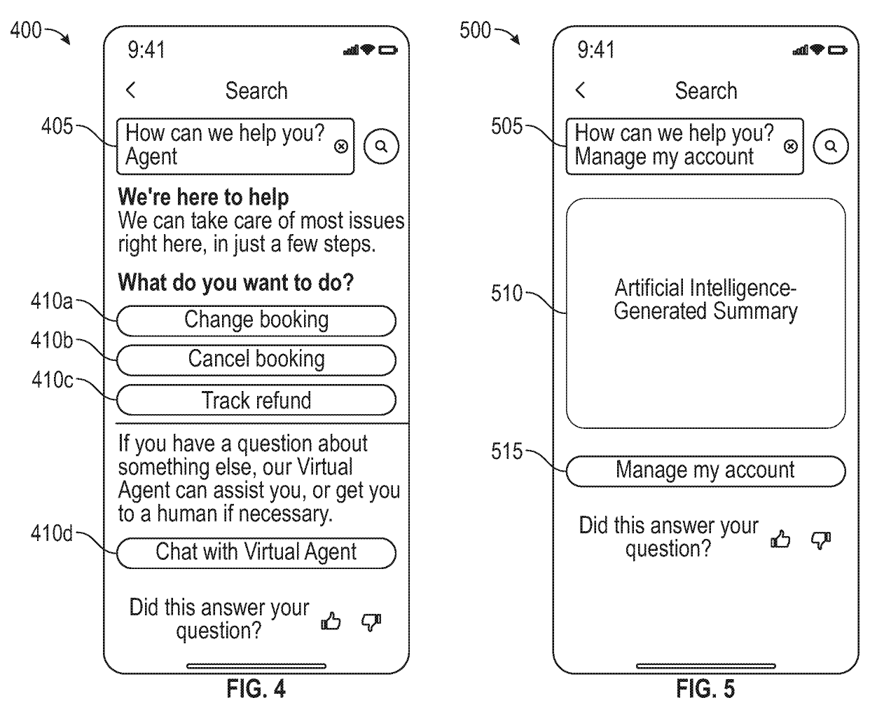

FIG. 4 depicts a GUI 400. The GUI 400 may be a GUI generated by the GUI generation circuit 130. The GUI 400 may be displayed on a user device 155 of a first type (e.g., smartphone, tablet). Additionally, or alternatively, the GUI 400, or an alternative implementation thereof, may be displayed on a user device 155 of a second type (e.g., laptop, desktop computer).

The GUI 400 may include a plurality of elements corresponding to managing travel reservations. The GUI 400 may include a search bar 405 that allows a user to input a natural language request for processing. For example, the search bar 405 may allow the user to input ‘Agent’ indicating that the user would like to converse (e.g., chat) with a virtual agent of the virtual agents 140 (e.g., via a chatbot interface). The GUI 400 may include a plurality of selectable elements corresponding to potential actions based on the request. For example, a first selectable element 410a may allow the user to change a booking (e.g., reservation). As another example, a second selectable element 410b may allow the user to cancel a booking (e.g., reservation). As yet another example, a third selectable element 410c may allow the user to track a refund status. The GUI 400 may include a fourth selectable element 410d to allow the user to chat with the virtual agent 140 (e.g., in the event the selectable elements 310a-c do not resolve the request).

FIG. 5 depicts a GUI 500. The GUI 500 may be GUIs generated by the GUI generation circuit 130. The GUI 500 may be displayed on a user device 155 of a first type (e.g., smartphone, tablet). Additionally, or alternatively, the GUI 500 may be displayed on a user device 155 of a second type (e.g., laptop, desktop computer).

The GUI 500 may include a plurality of elements corresponding to managing travel reservations. The GUI 500 may include a search bar 505 that allows a user to input a natural language request for processing. For example, the search bar 505 may allow the user to input ‘Manage my account’, indicating that the user would like to modify settings or information associated with their user account. The GUI 500 may include a first interface portion 510 including a summary response (e.g., generated by the AI model 125 and/or an artificial intelligence agent). The summary response may include a summary of one or more documents or information segments explaining how the user can manage their account. The GUI 500 may include a second interface portion including a selectable element 515 that allows the user to manage their account. For example, responsive to a user interaction with the selectable element 515, the user may be routed to a page where they can modify account settings.

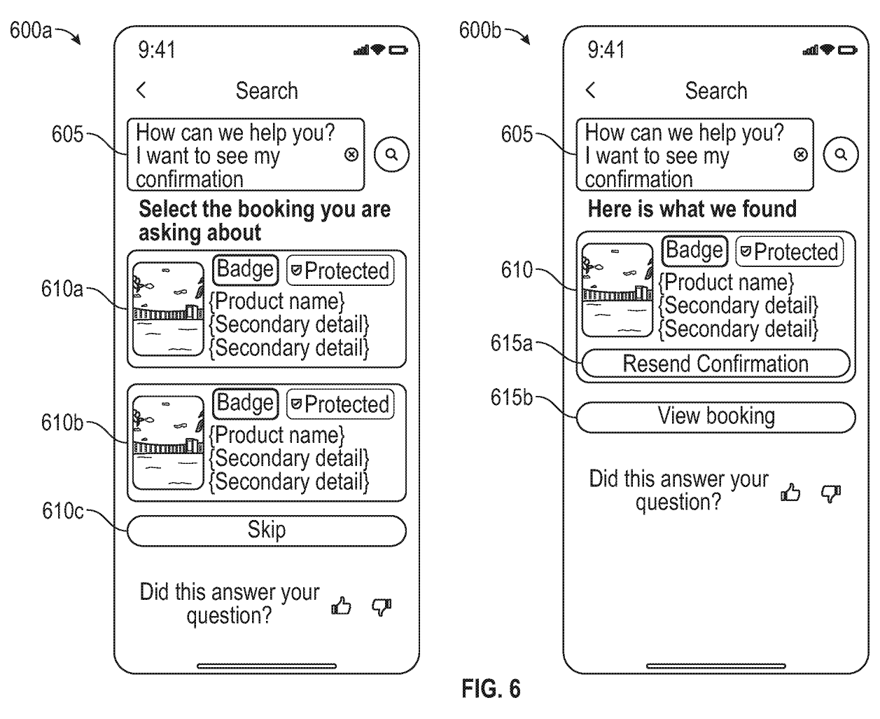

FIG. 6 depicts a plurality of GUIs 600 corresponding to a request for managing travel reservations. The GUIs 600 may be GUIs generated by the GUI generation circuit 130. The GUIs 600 may be displayed on a user device 155 of a first type (e.g., smartphone, tablet) and/or on a user device 155 of a second type (e.g., laptop, desktop computer). The GUIs 600 may include a search bar 605 that allows a user to input a natural language request for processing. For example, the search bar 605 may allow the user to input ‘I want to see my confirmation,’ indicating that the user would like to view or send confirmation information associated with a travel reservation. The GUIs 600 may include a plurality of different interface portions depending on whether travel reservations associated with the request are identified.

The GUIs 600 are shown to include a first GUI 600a, where multiple reservations are determined to be associated with the request. The GUI 600a may include previews 610 for each of the identified reservations. For example, the GUI 600a may include a first preview 610a corresponding to a first reservation, and a second preview 610b corresponding to a second reservation. The previews 610 may be selectable elements configured to be interacted with by the user. For example, the user may select one of the previews to identify a reservation for which the request is directed (e.g., associated). The GUI 600a may include a third selectable element 610c to allow the user to not choose a specific reservation.

The GUIs 600 are shown to include a second GUI 600b, where a single reservation is determined to be associated with the request. Additionally, or alternatively, the GUI 600b may be displayed in response to an interaction with the first preview 610a or the second preview 610b of the GUI 600a. The GUI 600b may include a preview 610 of the reservation. The preview 610 may include a title, description, images, and/or other information associated with the reservation. The GUIs 600b may include a plurality of selectable elements 615 corresponding to the reservation and the request. For example, the GUI 600b may include a first selectable element 615a to resend a confirmation of the reservation. As another example, the GUIs 600b may include a second selectable element 615b to view information of the reservation.

In some implementations, certain elements may be displayed responsive to a user interaction with one of the previews 610. For example, the GUI 600b may display a plurality of selectable elements 615 corresponding to the request and the selected preview 610. For example, the GUI 600b may include the first selectable element 615a and the second selectable element 615b for the selected preview 610. Additionally, or alternatively, a fourth selectable element may resend a confirmation email for all reservations associated with the request. As another example, a fifth selectable element may route the user to a different page to further refine the request or raise additional options for actions. In some implementations, the fifth selectable element may instantiate an artificial intelligence agents (e.g., of the virtual agents 140) to further assist with determining the action the user is trying to take.

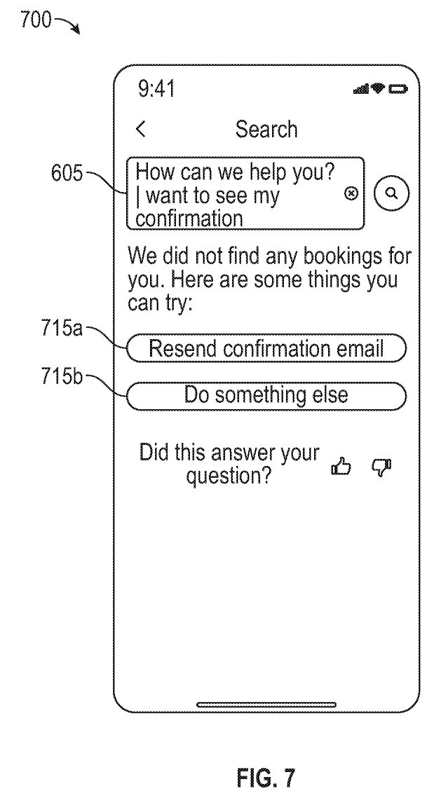

FIG. 7 depicts GUI 700, where no reservations are determined to be associated with the request described with reference to FIG. 6. The GUI 700 may include the first selectable element 715a and the second selectable element 715b. Responsive to an interaction with the first selectable element 715a, a confirmation email may be sent to all reservations associated with the account, regardless of whether they were determined to be associated with the request. Responsive to an interaction with the second selectable element 715b, the user may be routed to a different page to further refine the request.

While FIGS. 6 and 7 are shown to include GUIs associated with viewing a reservation confirmation, it should be understood that similar GUIs may be displayed in response to a plurality of different request types. According to an example implementation, the search bar 605 may allow the user to input ‘I want to see my booking,’ indicating that the user would like to view one or more travel reservations. The GUIs 600 may include a plurality of different interface portions depending on whether travel reservations associated with the request are identified. For example, the GUIs 600 may include a selectable element to manage settings or details of the reservation. As another example, the GUIs 600 may include a selectable element to resend a confirmation (e.g., message, email, etc.) of the reservation. As yet another example, a selectable element may route the user to a different page to view all of their reservations. As yet another example, a selectable element may allow the user to find (e.g., search for) a specific reservation.

According to another example implementation, the search bar 605 that allows a user to input ‘I want to change name on booking,’ indicating that the user would like modify a travel reservation. The GUIs 600 may include a plurality of different interface portions depending on whether travel reservations associated with the request are identified. For example, the GUIs 600 may include a selectable element to change the reservation (e.g., reservation details). As another example, the GUIs 600 may include a selectable element to do something else (e.g., perform a different action). As yet another example, a selectable element may allow the user to change reservation details not associated with the request.

According to another example implementation, the search bar 805 may allow the user to input ‘Track refund status,’ indicating that the user would like to view a status of a requested refund for a travel reservation. The GUIs 600 may include a plurality of different interface portions depending on whether travel reservations associated with the request are identified. For example, a selectable element may allow the user to track a refund. As another example, a selectable element may allow the user to track a refund status of all reservations (e.g., multiple reservations) associated with the user account.

According to another example implementation, the search bar 605 may allow the user to input ‘request refund of hotel,’ indicating that the user would like to request a refund, specifically for a hotel reservation type. The GUIs 600 may include a plurality of different interface portions depending on whether travel reservations associated with the request are identified. For example, the GUIs 600 may include a selectable element to view cancellation options for the reservation. As another example, a selectable element may allow the user to see cancellation options for any/all travel reservations associated with the user account.

According to another example implementation, the search bar 605 may allow the user to input ‘can I get a refund,’ indicating that the user would like to view cancellation and/or refund options for a reservation. The GUIs 600 may include a plurality of different interface portions depending on whether travel reservations associated with the request are identified. For example, the GUIs 600 may include a selectable element to view cancellation options for the reservation. As another example, the GUIs 600 may include a selectable element to initiate a chat with the virtual agent 140. As yet another example, the GUIs 600 may include a selectable element to allow the user to see cancellation options for any/all travel reservations associated with the user account.

Referring to FIGS. 1, 6, and 7, in some implementations, rather than generating interface portions responsive to a request input (e.g., as shown in FIGS. 6 and 7), the GUI generation circuit 130 may generate one or more interface portions to allow the user to manage travel reservations without entering a request. In some implementations, the GUI generation circuit 130 may generate a GUI indicating (e.g., associated) reservations corresponding to a single trip (e.g., event, travel itinerary). The GUI may include a preview of the trip. The preview may display information about the trip, such as the destination, dates associated with the trip, a number of bookings of the trip, among other information. The preview may include a plurality of selectable elements. Each selectable element may allow the user to view information associated with a specific booking of the trip.

In some implementations, the GUI may display an interface portion corresponding to each travel reservation of the trip. For example, a first interface portion may be for a flight reservation, and a second interface portion may be for a hotel reservation. Each interface portion may display information of the reservation, such as an itinerary number, a date range, among other information. Each interface portion may include a plurality of selectable elements corresponding to potential actions of the reservation. For example, the first interface portion may include selectable elements to change flights, cancel flights, resend confirmations, manage rewards, among other actions. As another example, the second interface portion may include selectable elements to change hotels, cancel hotels, resend confirmations, manage rewards, message hotel, among other actions.

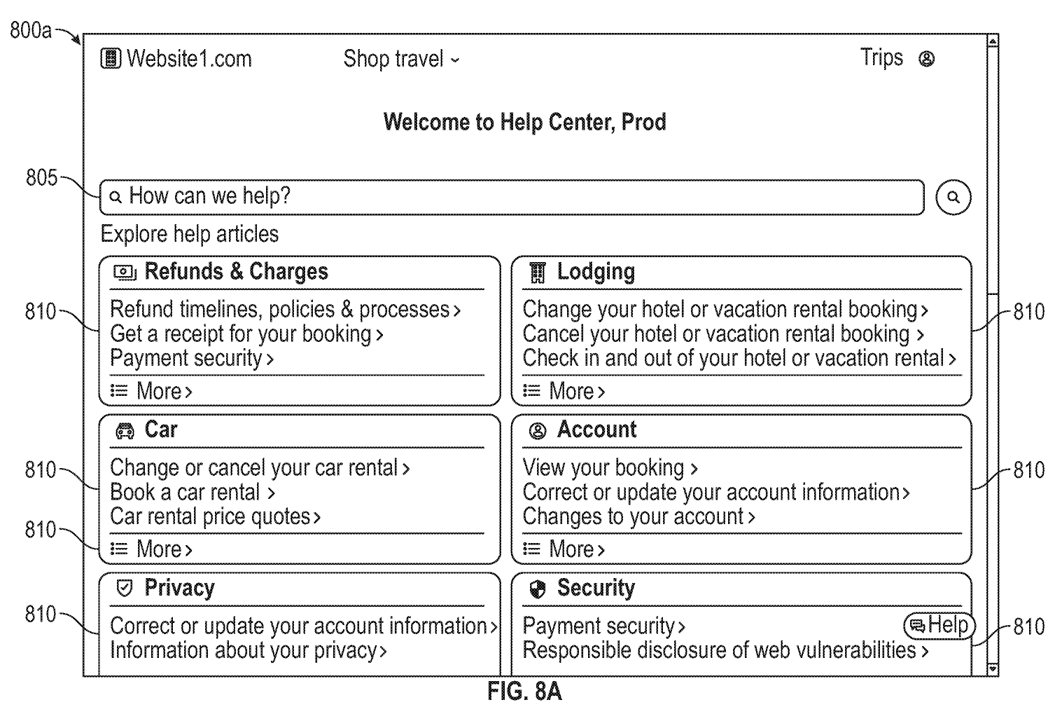

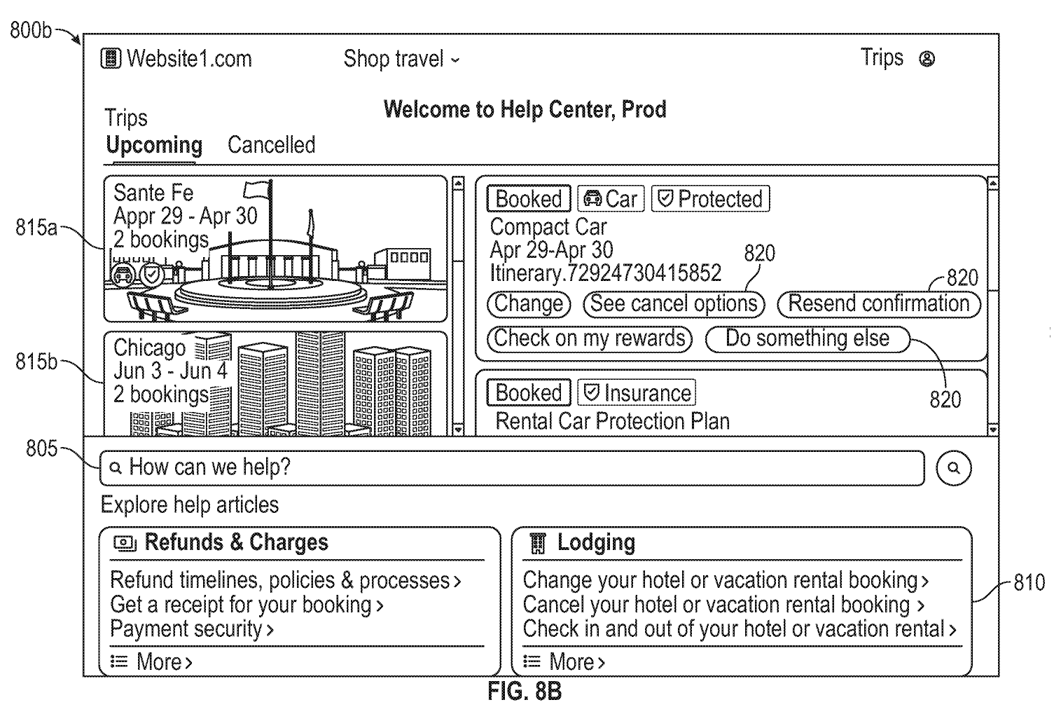

FIGS. 8A and 8B depict a first GUI 800a and a second GUI 800b generated by the GUI generation circuit 130. The first GUI 800a is shown to include a search bar 805 to allow the user to input a request associated with a travel reservation. The first GUI 800a is shown to include a plurality of selectable elements 810 corresponding to potential actions associated with travel reservations, account settings, privacy settings, security settings, among other potential actions. In some embodiments, interaction with a selectable element 810 may cause an action to be implemented. In some embodiments, interaction with a selectable element 810 may cause the user to be routed to a page that includes information related to the selectable element 810.

The second GUI 800b is shown to include the search bar 805, the selectable elements 810, and a plurality of previews 815 corresponding to trips including one or more reservation. For example, a first preview 815a may correspond to a first trip at a first destination during a first date range. As another example, a second preview 815b may correspond to second trip at a second destination during a second date range. The previews 815 may be selectable, such that the user may view reservation details for a trip responsive to selecting one of the previews 815. For example, responsive to interacting with the first preview 815a, the GUI 800b may display a plurality of selectable elements 820 corresponding to the reservations of the first trip.

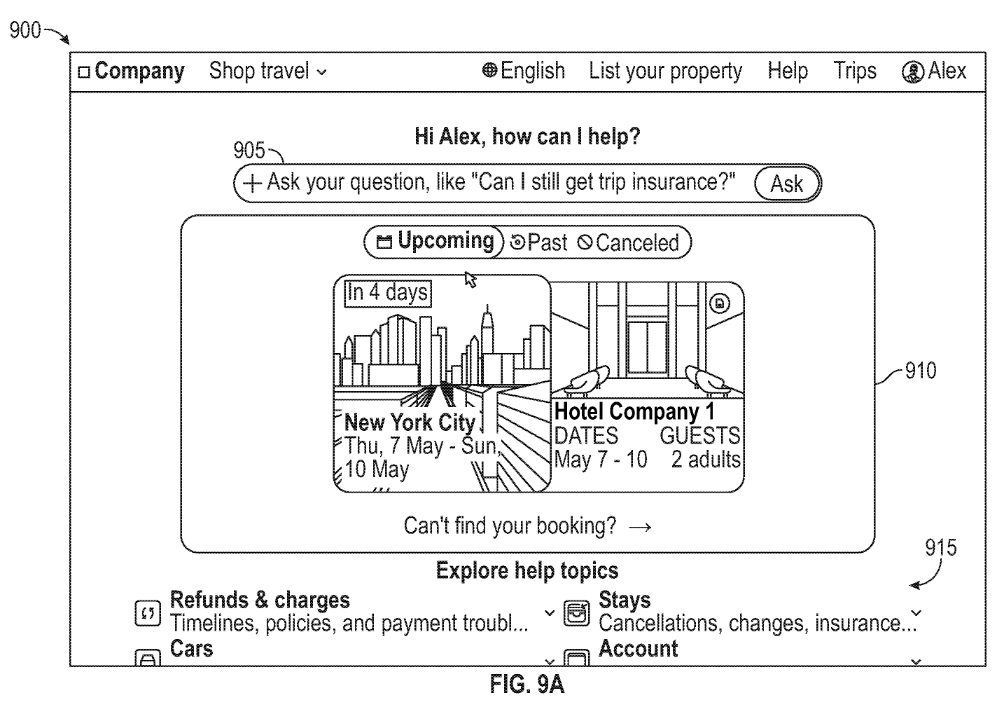

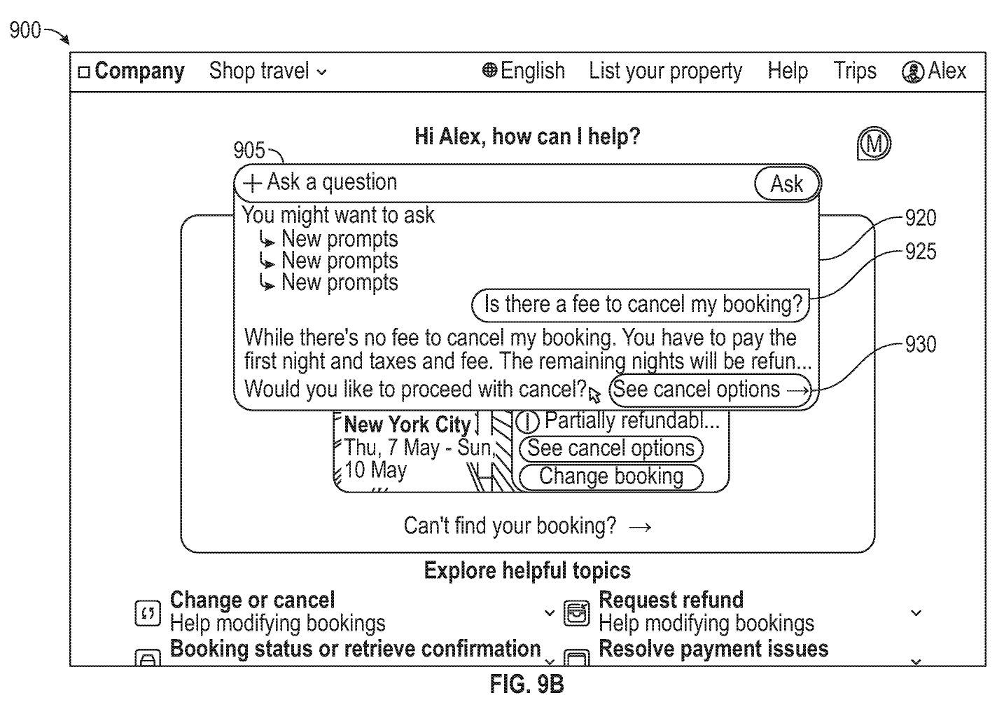

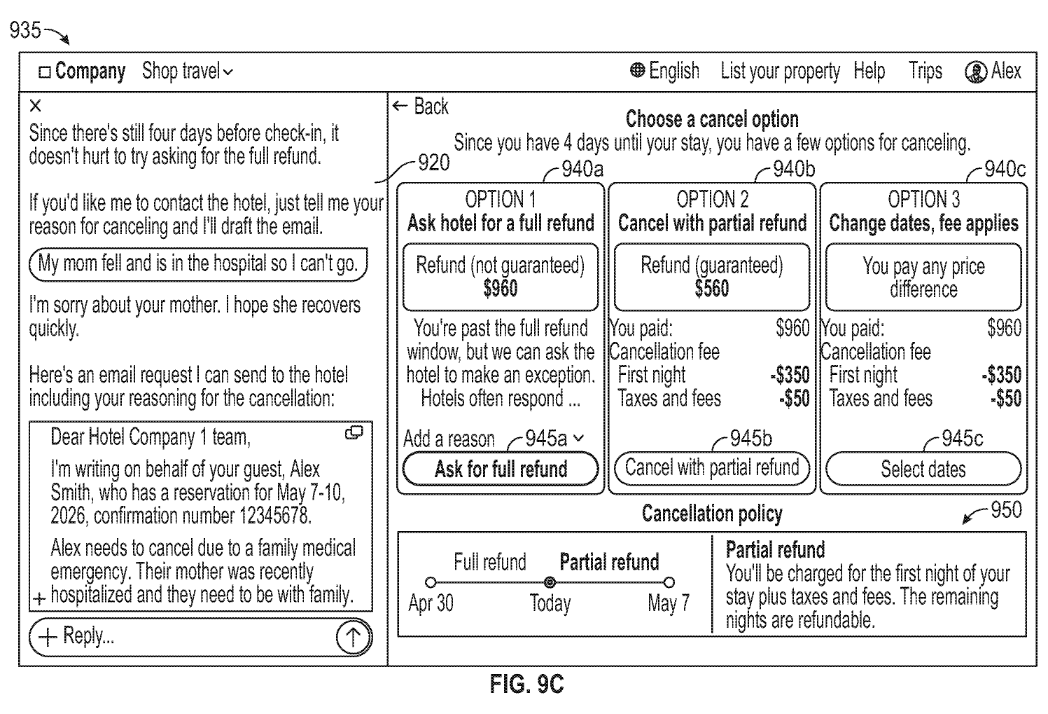

FIG. 9A depicts a GUI 900 for managing travel reservations, according to an example implementation. In some implementations, the GUI 900 is generated by the reservation management system 105 for display on the user device 155. The GUI 900 may serve as a dashboard for modifying travel reservations. As shown, the GUI 900 includes a search bar 905, a reservation preview 910, and an information window 915. The search bar 905 may be an interactive element that allows a user to input a request associated with modifying a travel reservation. While shown to be a text bar, the search bar 905 may be a different type of interactive element, such as a menu, a chatbot interface, or a different element.

The reservation preview 910 may display information associated with travel reservations corresponding to a user account. For example, the reservation management system 105 may retrieve account information associated with the user account, and display information associated with the travel reservations via the reservation preview 910. The reservation preview 910 may include location information, dates, itinerary information, images, and/or other information associated with travel reservations. In some implementations, the reservation preview 910 includes an interactive element that allows the reservation preview 910 to display different types of reservations. For example, the interactive element may allow the reservation preview 910 to display upcoming reservations, past reservations, and/or canceled reservations.

The information window 915 is shown to include a plurality of selectable elements corresponding to various topics associated with travel reservations. For example, the information window 915 may include information related to refunds, stays (e.g., hotels), car rentals, or account details, among other information. In response to an interaction with a topic, the GUI 900 may route the user to a page associated with the topic. For example, in response to an interaction with a topic related to refunds, the GUI 900 may route the user to a webpage or application page including information associated with refunds.

FIG. 9B depicts the GUI 900 in response to an interaction with the search bar 905, according to an example implementation. As shown, the user (e.g., of the user device 155) may interact with the search bar 905 to enter a request 925 associated with modifying a travel reservation. For example, the user may enter, ‘Is there a fee to cancel my booking?’ in the search bar 905. In response to the user entering the request 925, the GUI 900 is shown to display a chatbot interface 920. The chatbot interface 920 may allow the user to interact with a virtual agent 140 (e.g., an artificial intelligence agent) selected based on contextual information associated with the request 925. For example, in response to the user entering the request 925 associated with canceling a booking, the reservation management system 105 may select a cancelation advisory agent to interact with the user via the chatbot interface 920.

As described above, in response to receiving the request, the reservation management system 105 may determine that there is a travel reservation associated with the request 925. The reservation management system 105 may then generate a prompt for transmission to the virtual agents 140 including the request 925 and indicating a plurality of potential actions and reservation information associated with the user device. The virtual agent 140 may generate a response to be displayed via the chatbot interface 920. In some implementations, the virtual agent 140 may generate a response indicating a cancellation summary associated with the reservation. For example, the cancellation summary may indicate whether there is a fee to cancel the booking. The response may further include a selectable element 930 to route the user to view cancellation options associated with the request 925. For example, in response to an interaction with the selectable element 930, the reservation management system 105 may display a different GUI including a plurality of potential actions corresponding to the request 925.

FIG. 9C illustrates a GUI 935 displaying a plurality of potential actions associated with a request. In some implementations, the GUI 935 may be displayed in response to an interaction with the selectable element 930 described with reference to FIG. 9B. As shown, the GUI 935 includes a first potential action 940a, a second potential action 940b, and a third potential action 940c. Each of the first potential action 940a, the second potential action 940b, and the third potential action 940c are shown to include contextual summaries associated with the respective potential actions (e.g., generated by the selected virtual agent 140). For example, the first potential action 940a may have a contextual summary indicating that the user can request a full refund, the second potential action 940b may have a contextual summary indicating that the user can cancel with a partial refund, and the third potential action 940c may have a contextual summary indicating that the user can change dates of the reservation for a fee. In some implementations, the virtual agent 140 may rank the first potential action 940a, the second potential action 940b, and the third potential action 940c according to a predicted outcome associated with each potential action. For example, the virtual agent 140 may determine that the first potential action 940a has a best predicted outcome, followed by the second potential action 940b, and then the third potential action 940c.

In some implementations, the predicted outcomes may be based at least in part on policy information 950. The policy information 950 may indicate a policy associated with canceling the reservation. For example, the policy information 950 may indicate that a partial refund is currently available. The virtual agents 140 may use the policy information to determine the predicted outcomes associated with each potential action 940. For example, since a partial refund is currently available (e.g., as indicated in the policy information 950), the best potential action may be to request a full refund directly to a client device 170 (e.g., the first potential action 940a), as the predicted outcome may be a full refund as opposed to a partial refund (e.g., indicated by the second potential action 940b) and/or changing dates for a fee (e.g., indicated by the third potential action 940c).

Each of the first potential action 940a, the second potential action 940b, and the third potential action 940c are shown to include selectable elements 945. For example, the first potential action 940a includes a first selectable element 945a, the second potential action 940b includes a second selectable element 945b, and the third potential action 940c includes a third selectable element 945c. In response to receiving an interaction with one of the selectable elements 945, the reservation management system 105 may determine that the potential action associated with the selectable element is to be implemented. For example, in response to an interaction with the first selectable element 945a, the reservation management system 105 may determine that the virtual agent 140 is to generate a message to send to the client device 170 requesting a full refund for the reservation.

In some implementations, in response to an interaction with the first selectable element 945a, the virtual agent 140 may generate a message for transmission to the client device 170. As shown, the virtual agent 140 may prompt the user via the chatbot interface 920 to enter a reason for cancellation. In response to receiving the reason for cancellation, the virtual agent 140 may generate a natural language message for transmission to the client device 170. The message may indicate the reason for cancellation, and request a full refund in view of the reason for cancellation. The virtual agent 140 may display the message via the request processing circuit 120, and request a user approval of the message. In response to receiving the approval, the reservation management system 105 may transmit the message to the client device 170.

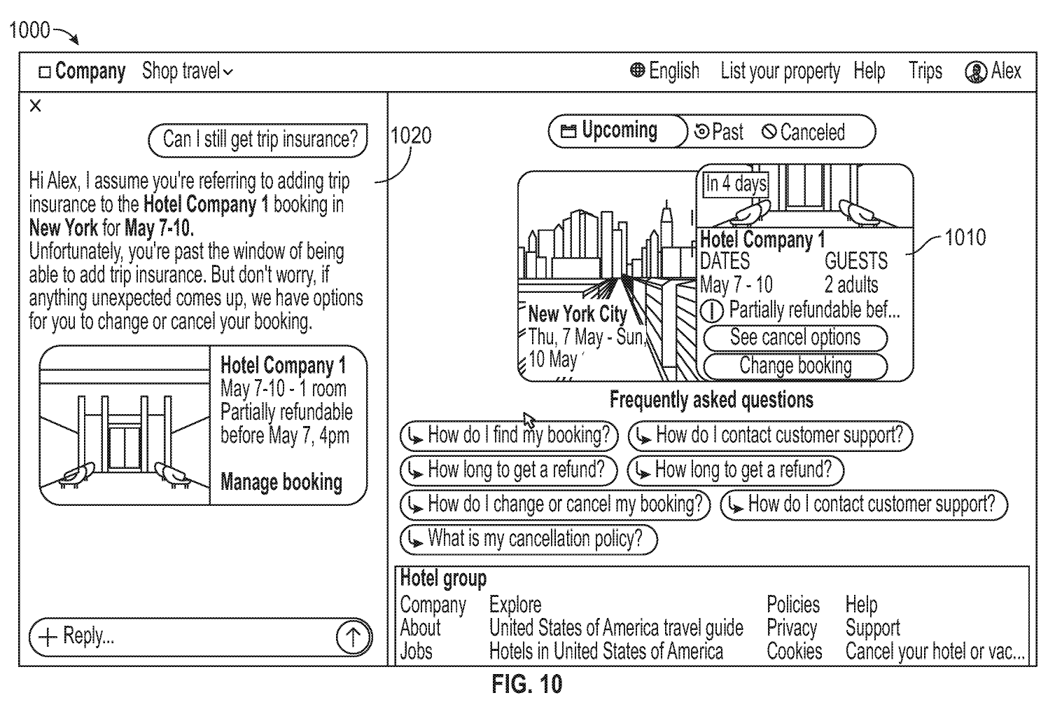

FIG. 10 depicts a GUI 1000 for responding to user queries. In some implementations, the GUI 1000 may include any/all features of the GUI 900 and/or the GUI 935 as described with reference to FIGS. 9A-9C. Additionally, or alternatively, the GUI 1000 may include different features than the GUI 900 and/or the GUI 935. As shown, the GUI 1000 includes a reservation preview 1010 and a chatbot interface 1020 for interacting with the virtual agent 140.

The reservation preview 1010 may display information associated with travel reservations corresponding to a user account. For example, the reservation management system 105 may retrieve account information associated with the user account, and display information associated with the travel reservations via the reservation preview 1010. The reservation preview 1010 may include location information, dates, itinerary information, images, and/or other information associated with travel reservations. In some implementations, the reservation preview 1010 includes an interactive element that allows the reservation preview 1010 to display different types of reservations. For example, the interactive element may allow the reservation preview 1010 to display upcoming reservations, past reservations, and/or canceled reservations.

The reservation management system 105 may receive a query associated with a travel reservation via the chatbot interface 1020. In some instances, the query may be incomplete, or may not provide enough information for the reservation management system 105 to make a definite determination on the travel reservation that the user is referring to in the query. For example, the query may ask ‘Can I still get trip insurance?’ without indicating a travel reservation for which the user is interested in trip insurance. In such instances, the reservation management system 105 may augment the query with reservation information such that the virtual agent 140 can infer which reservation is being indicated in the request.

According to an example implementation, the reservation management system 105 may process account information associated with the user to retrieve additional context associated with the query. For example, the reservation management system 105 may retrieve reservation types, reservation dates, or other reservation information. The reservation management system 105 may include at least a portion of the reservation information with the query when providing the query to the virtual agent 140. For example, the reservation management system 105 may include reservation information associated with a closest upcoming reservation. As another example, the reservation management system 105 may include reservation information associated with reservations of a certain type indicated in the request. By including reservation information within the request, the virtual agent 140 may infer which reservation the user is referring to in the request. This may reduce computational resource waste associated with generating responses for incorrect reservations, and/or transmissions associated with re-generating and displaying multiple responses via the GUI 1000.

The arrangement, construction, and description of the systems and methods as shown in the various exemplary examples are illustrative only. While some examples have been described herein, several modifications and/or adjustments are possible (e.g., variations in sizes, dimensions, structures, shapes, and proportions of the various elements, values of parameters, mounting arrangements, use of materials, colors, orientations, etc.). For example, the position of elements can be reversed or otherwise varied, and the nature or number of discrete elements or positions can be altered or varied. Accordingly, all such modifications are intended to be included within the scope of the present disclosure. The order or sequence of any process or method steps can be varied or re-sequenced according to alternative examples. Other substitutions, modifications, changes, and omissions can be made in the design, operating conditions, and arrangement of the exemplary examples without departing from the scope of the present disclosure.

The present disclosure contemplates methods, systems, and program products on any machine-readable media for accomplishing various operations. The examples of the present disclosure can be implemented using existing computer processors, or by a special purpose computer processor for an appropriate system, incorporated for this or another purpose, or by a hardwired system. Examples within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium, which can be used to carry or store desired program code in the form of machine-executable instructions or data structures, and which can be accessed by a general purpose or special purpose computer or other machine with a processor. Combinations of the above are also included within the scope of machine-readable media. Machine-executable instructions include, for example, instructions and data, which cause a general-purpose computer, special purpose computer, or special purpose processing machines to perform a certain function or group of functions.

As used herein, an element or step recited in the singular and proceeded with the word “a” or “an” should be understood as not excluding plural elements or steps, unless such exclusion is explicitly recited. Furthermore, references to “exemplary example,” “one example,” or “some example” of the present disclosure are not intended to be interpreted as excluding the existence of additional examples that also incorporate the recited features.

It should be noted that the term “exemplary” and variations thereof, as used herein to describe various examples, are intended to indicate that such examples are possible examples, representations, or illustrations of possible examples (and such terms are not intended to connote that such examples are necessarily extraordinary or superlative examples).

The patent claims at the end of this document are not intended to be construed as including means-plus function limitations (e.g., under 35 U.S.C. § 112(f)), unless traditional means-plus-function language is expressly recited, such as “means for” or “step for” language being expressly recited in the claim(s).

Although the figures show a specific order of method steps, the order of the steps may differ from what is depicted. Also, two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements and/or steps. Thus, such conditional language is not generally intended to imply that features, elements and/or steps are in any way required for one or more examples, or that one or more examples necessarily include logic for deciding, with or without other input or prompting, whether these features, elements and/or steps are included or are to be performed in any particular example. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

It may be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It may be further understood by those within the art that if a specific number of an introduced claim recitation is intended, such an intent may be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art may recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, or “at least one of A, B, or C” is used, in both cases such usage should be interpreted as covering any permutation of A, B, or C, alone or in combination, unless expressly indicated otherwise (e.g., “a system having at least one of A, B, and C” would include systems that have A alone, B alone, C alone, A and B together, A and C together, B and C together, and A, B, and C together). It may be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” may be understood to include the possibilities of “A” or “B” or “A and B.” Further, unless otherwise noted, the use of the words “approximate,” “about,” “around,” “substantially,” etc., mean plus or minus ten percent.

The term “coupled” and variations thereof, as used herein, means the joining of two members, directly or indirectly, to one another. Such joining may be stationary (e.g., permanent, or fixed) or moveable (e.g., removable, or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

In various implementations, the steps and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular industrial environment or portion of an industrial environment. In some implementations, the operations may be performed by a combination of one or more central or offsite computing devices/servers and one or more local controllers/computing devices. All such implementations are contemplated within the scope of the present disclosure. Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

As used herein, unless specifically indicated otherwise, the term "circuit" includes implementations in which the features and/or functionality are provided via: (1) instructions stored on a computer-readable storage medium (e.g., memory) that are executable by a processor, (2) general purpose or special purpose hardware, or (3) a combination thereof.

What is claimed is:

1. A travel reservation management system, comprising:
a non-transitory computer-readable medium having instructions stored thereon that, when executed by one or more processors, cause the one or more processors to:
receive, via a graphical user interface (GUI) generated on a user device associated with a user account, a request associated with a travel reservation, the request comprising a natural language request for assistance in modifying the travel reservation;
determine, based on contextual information associated with the request and account information associated with the user account, that the travel reservation is associated with the user account;
determine, based on the contextual information associated with the request, a plurality of potential actions for modifying the travel reservation;
generate a prompt for transmission to an artificial intelligence agent indicating the plurality of potential actions and reservation information associated with the travel reservation;
transmit the prompt to the artificial intelligence agent to cause the artificial intelligence agent to generate a contextual summary of the plurality of potential actions, the contextual summary indicating a recommended action of the plurality of potential actions;
generate, for display on the GUI, an interface portion corresponding to the travel reservation, the interface portion comprising the contextual summary and selectable elements corresponding to the plurality of potential actions;
receive, via the GUI, an interaction with a selectable element of the selectable elements corresponding to a first potential action of the plurality of potential actions; and
implement the first potential action to adjust one or more features of the travel reservation.

2. The travel reservation management system of claim 1, wherein the instructions further cause the one or more processors to:
determine, based on the contextual information associated with the request, a request type of a plurality of request types corresponding to the request;
determine, based on the request type, the plurality of potential actions; and
select the artificial intelligence agent corresponding to the request type from a plurality of artificial intelligence agents corresponding to the plurality of request types.

3. The travel reservation management system of claim 1, wherein the instructions further cause the one or more processors to transmit the prompt to the artificial intelligence agent to cause the artificial intelligence agent to generate the contextual summary by:
retrieving, based on the reservation information, policy information associated with the travel reservation;
determining, based on the policy information, predicted outcomes associated with the plurality of potential actions; and
generating, based on comparing the predicted outcomes, the contextual summary indicating the recommended action.

4. The travel reservation management system of claim 1, wherein the instructions further cause the one or more processors to:
receive, via the GUI in response to displaying the interface portion, a query associated with at least one potential action of the plurality of potential actions;
retrieve, from a database and based on the query, one or more information segments corresponding to the query and the at least one potential action;
generate a prompt for transmission to the artificial intelligence agent indicating the query, the at least one potential action, and the one or more information segments; and
transmit the prompt to the artificial intelligence agent to cause the artificial intelligence agent to generate a response to the query.

5. The travel reservation management system of claim 1, wherein the instructions further cause the one or more processors to:
retrieve, based on the contextual information associated with the request, a plurality of documents corresponding to the contextual information from among a database of documents based at least in part on an estimated relevance of the documents to the request;
generate a prompt using the request and the plurality of documents and provide the prompt to an artificial intelligence model configured to generate a summary response to the request; and
generate, for display on the GUI, the interface portion comprising at least a portion of the summary response.

6. The travel reservation management system of claim 1, wherein the instructions further cause the one or more processors to:
receive the interaction with the selectable element corresponding to the first potential action, wherein the first potential action indicates a request to contact a client device associated with the travel reservation to request cancellation of the travel reservation;
generate, using the artificial intelligence agent and based on the first potential action, a natural language message comprising a request for cancellation;
receive, via the GUI, an approval of the natural language message; and
transmit the request to the client device.

7. The travel reservation management system of claim 6, wherein the instructions further cause the one or more processors to:
in response to receiving the interaction with the selectable element, generate, for display on the GUI, an additional interface portion requesting a reason for cancellation;
receive, via the GUI in response to an interaction with the additional interface portion, the reason for cancellation; and
generate the natural language message comprising the request for cancellation and the reason for cancellation.

8. The travel reservation management system of claim 6, wherein the instructions further cause the one or more processors to:
receive, from the client device, a response indicating whether the request for cancellation was granted;
determine, based on the response, that the request for cancellation was not granted; and
generate an additional prompt for transmission to the artificial intelligence agent indicating the response and one or more remaining potential actions, to cause the artificial intelligence agent to generate an updated contextual summary of the plurality of potential actions, the updated contextual summary indicating an updated recommended action of the one or more remaining potential actions.

9. The travel reservation management system of claim 1, wherein the natural language request comprises at least one of a text-based request or a speech-based request associated with the travel reservation.

10. The travel reservation management system of claim 1, wherein the request comprises the natural language request for cancelling the travel reservation, and wherein the plurality of potential actions comprises at least one of cancelling the travel reservation, modifying a time corresponding to the travel reservation, and contacting a client device associated with the travel reservation.

11. The travel reservation management system of claim 1, wherein the instructions further cause the one or more processors to:
determine, based on contextual information associated with the request and account information associated with the user account, that there are multiple travel reservations associated with the user account corresponding to the travel reservation;
generate, for display on the GUI, a preliminary interface portion comprising selectable elements corresponding to the multiple travel reservations;
receive, via the GUI, an interaction with a first selectable element of the selectable elements corresponding to a first travel reservation of the multiple travel reservations; and
determine, based on the interaction, that the travel reservation associated with the request is the first travel reservation.

12. A method for modifying travel reservations, comprising:
receiving, a request associated with a travel reservation, the request comprising a natural language request for assistance in modifying the travel reservation;
determining, based on contextual information associated with the request and account information associated with a user account, that the travel reservation is associated with the user account;
determining, based on the contextual information associated with the request, a plurality of potential actions for modifying the travel reservation;
generating a prompt for transmission to an artificial intelligence agent indicating the plurality of potential actions and reservation information associated with the travel reservation;
transmitting the prompt to the artificial intelligence agent to cause the artificial intelligence agent to generate a contextual summary of the plurality of potential actions, the contextual summary indicating a recommended action of the plurality of potential actions;
receiving an indication of a first potential action of the plurality of potential actions; and
implementing the first potential action to adjust one or more features of the travel reservation.

13. The method of claim 12, further comprising:
determining, based on the contextual information associated with the request, a request type of a plurality of request types corresponding to the request;
determining, based on the request type, the plurality of potential actions; and
selecting the artificial intelligence agent corresponding to the request type from a plurality of artificial intelligence agents corresponding to the plurality of request types.

14. The method of claim 12, wherein transmitting the prompt to the artificial intelligence agent to cause the artificial intelligence agent to generate the contextual summary by:
retrieving, based on the reservation information, policy information associated with the travel reservation;
determining, based on the policy information, predicted outcomes associated with the plurality of potential actions; and
generating, based on comparing the predicted outcomes, the contextual summary indicating the recommended action.

15. The method of claim 12, further comprising:
receiving a query associated with at least one potential action of the plurality of potential actions;
retrieving, from a database and based on the query, one or more information segments corresponding to the query and the at least one potential action;
generating a prompt for transmission to the artificial intelligence agent indicating the query, the at least one potential action, and the one or more information segments; and
transmitting the prompt to the artificial intelligence agent to cause the artificial intelligence agent to generate a response to the query.

16. The method of claim 12, further comprising:
retrieving, based on the contextual information associated with the request, a plurality of documents corresponding to the contextual information from among a database of documents based at least in part on an estimated relevance of the documents to the request; and
generating a prompt using the request and the plurality of documents and provide the prompt to an artificial intelligence model configured to generate a summary response to the request.

17. The method of claim 12, further comprising:
receiving the indication of the first potential action, wherein the first potential action indicates a request to contact a client device associated with the travel reservation to request cancellation of the travel reservation;
generating, using the artificial intelligence agent and based on the first potential action, a natural language message comprising a request for cancellation;
receiving an approval of the natural language message; and
transmitting the request to the client device.

18. The method of claim 17, further comprising:
in response to receiving the indication of the first potential action, requesting a reason for cancellation;
receiving the reason for cancellation; and
generating the natural language message comprising the request for cancellation and the reason for cancellation.

19. The method of claim 17, further comprising:
receiving, from the client device, a response indicating whether the request for cancellation was granted;
determining, based on the response, that the request for cancellation was not granted; and
generating an additional prompt for transmission to the artificial intelligence agent indicating the response and one or more remaining potential actions, to cause the artificial intelligence agent to generate an updated contextual summary of the plurality of potential actions, the updated contextual summary indicating an updated recommended action of the one or more remaining potential actions.

20. A travel reservation management system, comprising:
a non-transitory computer-readable medium having instructions stored thereon that, when executed by one or more processors, cause the one or more processors to:
receive, from a graphical user interface (GUI) generated on a user device associated with a user account, a request associated with a travel reservation, the request comprising a natural language request for assistance in modifying the travel reservation;
retrieve, based on contextual information associated with the request, a plurality of documents corresponding to the contextual information, retrieving the plurality of documents comprising identifying the plurality of documents from among a database of documents based at least in part on an estimated relevance of the documents to the request;
generate a prompt using the request and the retrieved one or more documents and provide the prompt to a generative artificial intelligence model configured to generate a summary response to the request; and
generate, for display on the GUI, a first interface portion comprising at least a portion of the summary response.
